(19) United States
(12) Patent Application Publication
(10) Pub. No.: US 2025/0381573 A1
(43) Pub. Date: Dec. 18, 2025

(54) DUCKBILL NOZZLE ASSEMBLY

(71) Applicant: CLiCS, LLC, San Diego, CA (US)

(72) Inventors: Christopher MUNZ, Reno, NV (US); Jeffrey F. MACEDO, Sparks, NV (US); Jeffrey S. PLOETNER, San Diego, CA (US); Charles D. BROWN, San Diego, CA (US); Leilani M. MACEDO, La Jolla, CA (US)

(21) Appl. No.: 18/877,545

(22) PCT Filed: Jun. 27, 2023
(86) PCT No.: PCT/US2023/069204

§ 371 Date: Dec. 20, 2024

Related U.S. Application Data
(60) Provisional application No. 63/356,809, filed on Jun. 29, 2022.

(51) Int. Cl. B05B 1/30; A45D 34/00

(52) U.S. Cl. CPC B05B 1/3006; A45D 34/00; A45D 2034/005

(57) ABSTRACT

A nozzle assembly for dispensing a fluid product is disclosed herein. The dispensing nozzle assembly includes an upper nozzle plate adapted to mate with a canister and a duckbill valve. The nozzle assembly also includes a lower nozzle plate coupled to the upper nozzle plate and which accommodates the duckbill valve. The duckbill valve may have a base portion which is secured between the lower nozzle plate and upper nozzle plate. The upper nozzle may include an aperture for receiving a canister valve. The upper nozzle may include a diverter which forms a part of the aperture. Product is dispensed from the canister and through the nozzle assembly. The duckbill valve deforms to an open position to allow the product to be dispensed and reforms to a closed position after dispensing has stopped.

### REFERENCE TO RELATED APPLICATIONS

This application claims the benefit of U.S. Provisional Application No. 63/356,809, filed Jun. 29, 2022, which is hereby incorporated by reference in its entirety.

### BACKGROUND OF THE INVENTION

Electronically controlled hair dye dispensing systems are becoming increasingly popular in the hair salon industry and allow for mechanized distribution and mixing of hair dyes. The components that are used to create hair coloring compositions are generally distributed separately in containers such as tubes or bottles and allow a stylist to create custom hair dye blends for their clients. Additionally, the components of the hair coloring composition are generally provided separately to prolong their useful life and avoid adverse chemical reactions that may occur if the components were to be combined together and stored for extended periods of time.

### SUMMARY OF THE INVENTION

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

According to some embodiments herein, a product dispensing nozzle assembly includes an upper nozzle plate adapted to mate with a canister and a duckbill valve, and a lower nozzle plate coupled to the upper nozzle plate and including a central through hole traversed by the duckbill valve, where the duckbill valve includes an elastomeric tip which is self-closing. In some embodiments, the upper nozzle plate includes an aperture configured to receive a valve of the canister. In some embodiments, the aperture is located within an extruded housing portion of the upper nozzle plate. In some embodiments, the upper nozzle plate includes a diverter which forms a part of the aperture. In some embodiments, the duckbill valve further includes a base portion which is secured between the lower nozzle plate and the upper nozzle plate. In some embodiments, the base portion features an inlet, where the inlet is in fluid communication with the diverter of the upper nozzle plate. In some embodiments, the product dispensing nozzle assembly further includes one or more hooks coupling the upper nozzle plate to the lower nozzle plate. In some embodiments, the upper nozzle plate is coupled to the lower nozzle plate by means of one or more of an ultrasonic weld, heat stake, glue, or mechanical fastener. In some embodiments, the upper nozzle plate is coupled to the lower nozzle plate by heat staking. In some embodiments, the lower nozzle plate is conical in shape. In some embodiments, the lower plate further includes a ring wall that extends vertically from the inverted portion, and where the ring wall accommodates the upper nozzle plate. In some embodiments, the lower nozzle plate includes a rib wall. In some embodiments, the rib wall is concentric with, and offset from, the central through hole. In some embodiments, the elastomeric tip includes silicone.

### BRIEF DESCRIPTION OF THE DRAWINGS

FIG. 1A is a schematic diagram of a system environment incorporating the apparatus in accordance with some embodiments.

FIG. 1B is a perspective view of the external portion of a system for hair dye dispensing with a wiper assembly installed, according to some embodiments.

FIG. 1C is an interior perspective view of the canister system in the hair dispensing system of FIG. 1B incorporating a wiper assembly in accordance with some embodiments, according to some embodiments.

FIG. 2 is an isometric view of a wiper plate and wipers of the wiper assembly, according to some embodiments.

FIG. 3 is a top view of the wiper plate shown in FIG. 2, according to some embodiments.

FIG. 4 is an isometric view of a wiper plate with magnetic features, according to some embodiments.

FIG. 5 is an isometric view of a wiper that can be installed into a wiper plate, according to some embodiments.

FIG. 6 is an exploded view of a duckbill nozzle assembly and canister, according to some embodiments.

FIG. 7 is an exploded view of a duckbill nozzle assembly, according to some embodiments.

FIG. 8 is a side view of an assembled duckbill nozzle assembly, according to some embodiments.

FIG. 9 is a top view of an assembled duckbill nozzle assembly, according to some embodiments.

FIG. 10 is a cross-sectional view of the upper nozzle of a duckbill nozzle assembly, according to some embodiments.

FIG. 11 is an isometric view of a lower nozzle assembled with a duckbill nozzle, according to some embodiments.

FIG. 12 is a schematic drawing of a duckbill assembly dispensing a substance, according to some embodiments.

FIG. 13 is a schematic drawing of a wiper assembly and duckbill nozzle assembly in use and contacting one another, according to some embodiments.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

Embodiments relate to a dye dispensing system which dispenses dye from a canister, through a valve, and into a receptable. Such systems may operate more optimally when they remain free from debris or fluids that may hinder the mechanical function of the system. For example, in systems that dispense fluids through a nozzle, there is a need for the nozzles to remain free from leftover fluids after the dispensing occurs, as leftover fluids can dry and clog the nozzle or otherwise affect the fluid stream upon future use. Unclean nozzles may negatively impact the accuracy in the amount of fluid that is dispensed and may impair the direction in which the fluid is dispensed. Further, unclean nozzles contribute to a buildup of dispensed fluid in other areas of the dispensing system, which can impair the mechanical functions of the overall system.

Embodiments of the dye dispensing apparatus, system and method described herein dispense dye that is used for coloring hair and have the ability to produce almost an unlimited number of unique color formulations. In addition, the system may be programmed to perform a variety of optional treatments with computer controlled, precision dispensing. Mixable color formulations may be created by master chemists and produced in large batches remotely, such as at a factory, then packaged in recyclable, optionally refillable and reusable canisters. By way of example, the canisters may be pressurized piston canisters, bag-on-valve canisters, or aerosol canisters. The dye dispensing apparatus, system and method may dispense the dye from the canister such as “base tones” or “base levels” which may comprise a large portion of the dispensed color formulation; “pure tones” or “tonal values” which are highly concentrated dyes of particular colors; and “developer” which may be different strengths of peroxide, and bleach or other additives and treatments. Combining these ingredients produces unique formulations. The products in the canisters may consist of dyes, permanents, semi-permanents, demi-permanents, bleaches/lighteners, color refreshers, temporaries, co-bonder, additives, treatments, toners or developers. The consistency of the products may vary such that the texture and may be fluid, granular, powder etc. As used throughout the specification, the terms “dye” or “fluid” refer to the product, which may include but is not limited to, a dye or fluid.

In one embodiment, the canisters are configured with an internal valve that enables almost all of the dye in the canister to be dispensed without contamination from other dye sources. The system also may include the functionality of inventory management and communications.

The canisters of the system are attached to a nozzle assembly through which dye is dispensed. This nozzle assembly minimizes the amount of leftover dye that remains on and in the nozzle after dispensing due to the shape of the nozzle and its material properties which allow the nozzle to deform and then reform to its original shape. Specifically, the shape of the nozzle resembles that of a duck bill which is tapered to a slit-like opening that remains closed without interaction. Upon dispensing fluid through the duck bill nozzle, the slit-like opening opens to allow the fluid to pass through and thereafter closes when the dispensing stops to restore the duckbill shape. Thus, when dispensing is stopped, the nozzle functions to essentially pinch-off the stream of product coming through the nozzle. This in effect seals off the inside of the nozzle from the outside air and reduces the amount of product that clings to the nozzle.

In one embodiment, the nozzle assembly interacts with a wiper assembly to further reduce the amount of residual dye that remains on, or just inside of, the nozzle. The wiper assembly features a plate portion with an opening for fluid to be dispensed through. Flanking the opening are wipers that are used to clean the nozzle assembly when a canister is moved into and out of a dispensing position. These wipers function by contacting the nozzle to clean the nozzle assembly of residual fluid both before and after a fluid is dispensed. This wiper assembly can be attached below a tray which holds the canisters such that when the tray moves a canister into dispensing position, the nozzle assembly contacts the wipers. The wipers may be rubber or another elastomeric material that physically contacts the valve of the nozzle to remove excess product.

The combination of the wiper assembly and nozzle assembly function to remove all or nearly all of the residual fluid that remains on the nozzle tip following a dispense cycle. Upon contact between the wiper and the nozzle, the wiper causes the nozzle to deform and wipes off any product that remains outside or on the tip of the nozzle. In some embodiments, the force of the wiper squeezes out some or all of the remaining product that is found in the nozzle. By wiping any residual product off the tip of the nozzle assembly and/or deforming the nozzle to remove internal leftover product, the wiper prevents product from drying and clogging the nozzle on future dispenses. This keeps the dispensed fluid within the confines of the dispensing area and prevents it from spreading throughout the system. This in turn keeps the system clean and operating optimally.

Further, by compressing and deforming the nozzle to remove excess fluid, the wiper and nozzle assemblies ensure optimal fluid dispensing as there is no fluid left on and/or within the nozzle to dry, harden, and potentially distort a future fluid stream. In addition, the wiper assembly and nozzle assembly make cleaning the system simple as when a user cleans the system they only need to clean one component, the wiper assembly. A user may also instruct the system to initiate a self-cleaning process where one or more canisters dispense a small amount of fluid and are then subsequently wiped. In addition, during regular operation all the nozzles may be regularly wiped even if they are not dispensed from, as the canisters are moved around the system. This ensures that the nozzles are regularly wiped so that they do not clog between periods of use.

The dye dispensing apparatus, system and method may monitor the individual canisters and transmit actual dispensed amounts to the network or central server (e.g., a cloud-based application, a standalone server device, etc.) which, in turn, may automate inventory management by initiating automated direct replenishment shipments of the canisters. The dye dispensing system may be operated by stylists using control panels or Apps on mobile devices such as a laptop, tablet, smartphone or Web browser. Commands may be transmitted to the system from software operating on an online server or from the central server.

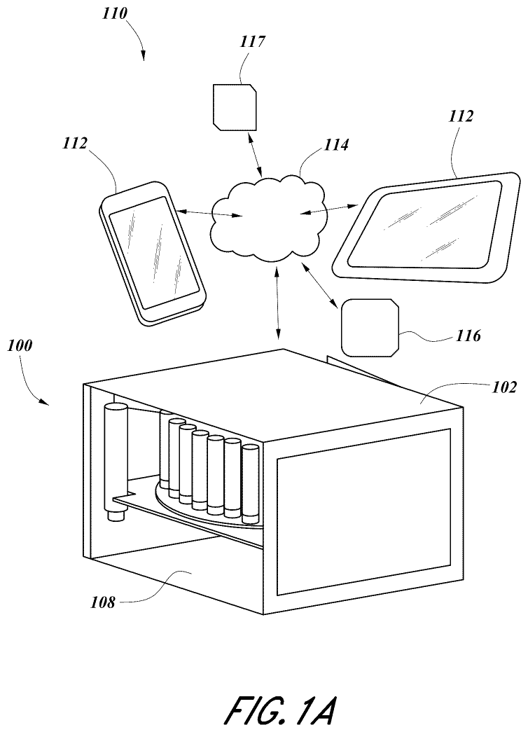

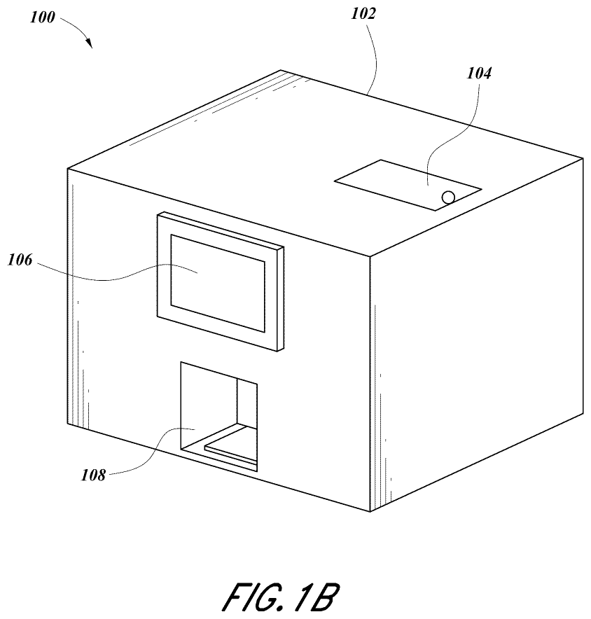

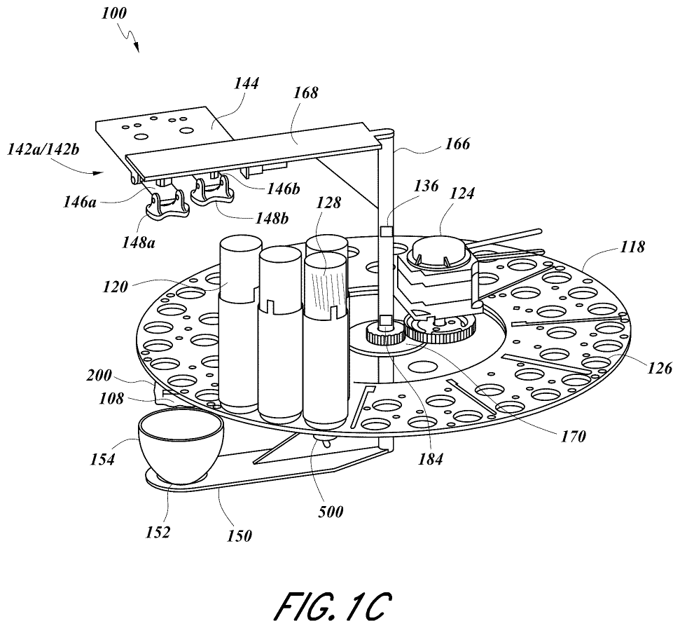

FIG. 1A is a simplified schematic diagram of a dye dispensing system 110 environment incorporating an apparatus 100 in accordance with some embodiments. For example, the apparatus 100 may be in communication with one or more mobile devices 112 through a network 114. The apparatus 100 includes a controller 116. The controller 116 may be contained within the housing 102 or located remotely from the apparatus 100, and in communication with the system 110 through the network 114, such as the Internet, a wide area network (WAN), a local area network (LAN), etc. Thus, the controller 116 may be a micro-control unit embedded in the apparatus 100, a separate standalone remote controller or computer, a cloud-based application, or other appropriate device or combination of devices. The controller 116 may include one or more CPU or processor boards, computer displays, touch screens and interface hardware. The communication or transmitting may be wired or wireless (or a hybrid combination thereof) and may be achieved through a Wi-Fi system, Bluetooth® wireless technology, Ethernet, router, cellular communications, satellite communications or the like. The system may also be capable of performing as a Wi-Fi access point. In various embodiments, the controller 116 is a laptop, computer or mobile device such as a tablet or mobile phone. In another embodiment, a user interface may be part of the controller 116 such as when the controller 116 is configured as a laptop, computer, tablet or mobile device 112, and may be used to enter inputs for communication with the apparatus 100 or system 110, or as an information center.

A dye formulation identifies at least one dye and an amount of the dye. Typically, a dye formulation includes the amounts of each of the various dyes and other developers or agents that are used to create the proper mixture for dying a client's hair to the correct target color. This dye formulation may be the recipe to create the hair coloring compositions for the coloring or treatment service to be performed on a client. In certain embodiments, the dye formulation is comprised of data 117 from an internal database, an external database or input from a user. In certain embodiments, the database contains files or records associated with a canister and/or tray of the system.

Through the network 114, requests, commands, responses and data may be transmitted. In certain embodiments, the apparatus 100 and system 110 may support the Dynamic Host Configuration Protocol (DHCP) assignment of internal IP addresses and may initiate communications over the network 114 in response to inputs. The network 114 may utilize Ethernet and Internet protocols such as TCP/IP, UDP, HTTP or HTTPS and data formats such as HTML, JSON or XML for these transactions. In various embodiments, these communications may include user interface interactions, periodic apparatus 100 timeouts, a system 110 event such as the canister being inserted or removed, or the completion of the dispensing sequence. Communications between the apparatus 100 and the controller 116 may be via a direct or independent access channel through the network 114. In the event that the primary network connectivity becomes unavailable, a backup system may be used, that is capable of reporting GPS coordinates and supporting operating communications.

FIGS. 1B-C show perspective views of a hair dye dispensing apparatus 100 or system according to an example embodiment. FIG. 1C shows the apparatus 100 without a housing 102. Here, a wiper assembly 200 is shown coupled to a tray 118 and a duckbill nozzle assembly 500 is located on a canister 120.

According to this embodiment, the dye dispensing apparatus 100 has a housing 102 which may be made from metal, plastic, composites or a combination thereof. A door 104 is located in the upper area of the housing 102 for access to the inside of the housing 102 such as for loading and unloading canisters or resolving any concerns that may arise. The door 104 may have a lock option (not shown). A panel 106 at the front of the dispensing apparatus 100 may include a screen or display to take inputs for communication with the dye dispensing apparatus 100 or to serve as an information center. For example, a screen or display on the panel 106 may display a power mode, a login function, a queue for dispensing, and system messages. The hair color or dye may be dispensed in a dispensing area 108 located in a lower area of the housing 102.

In some embodiments, each canister 120 is labeled with a unique identifier 128 such as a barcode, QR code, catalog number or icon code. The identifier 128 may be scanned, read and recognized by a device such as a reader 136. The reader 136 may be a standalone unit or part of the controller 116 and located within the housing. The reader 136 may be coupled to the side wall or top wall of the housing, on the dispenser or any location with a direct view of the canisters 120. In certain embodiments, other technologies may be used for uniquely identifying the canisters 120 such as by RFID (radio-frequency identification) technology, NFC (near-field communication) technology or the like. In some embodiments, the identifier 128 verifies the presence of the canister 120 in the apparatus 100 and identifies the particular contents in the canister 120 such as the color of the dye. Other information may be included in the identifier 128 such as the product name, date the canister 120 was filled with the particular dye, the amount of the dye remaining in the canister 120, a lot or batch number and any other notes the manufacturer may wish to include.

The reader 136 communicates with the controller 116. The reader 136 is configured to scan, read and recognize the identifier 128 labeled on the canister 120 and communicates the information to the controller 116. The controller 116 may recognize the information embedded in the identifier 128 such as product name, quantity remaining in the canister 120 and lot or batch number. In another embodiment, there may be two or more readers 136 designed to identify the canister 120 located in particular areas of the tray 118. For example, one reader 136 may identify the canisters 120 in an inner row of the tray 118 while another reader 136 identifies the canisters 120 in the outer row of the tray 118.

The tray 118 within the housing 102 may be coupled to the housing 102 and is configured to hold at least one canister 120. A bearing 170 may be coupled to the tray 118, enabling the tray 118 to rotate. The tray 118 may have any shape such as a round, carousel configuration and may be operated by a drive mechanism 124 such as a motor. The tray 118 communicates with the controller 116. In other embodiments, the tray 118 is fixed. The tray 118 is configured with at least one opening 126 to hold a canister 120.

In some embodiments, there may be multiple rows of openings 126, such as two concentric rows as shown. In some embodiments, the tray 118 may contain up to 50 openings 126 arranged in two rows, having an inner row with 20 openings 126 and an outer row with 30 openings 126. In some embodiments, the tray 118 may contain 35 openings 126 with an inner row with 14 openings 126 and an outer row with 21 openings 126. In other embodiments, the tray 118 may be square-shaped with 40 openings 126 arranged in four rows. In yet another embodiment, the tray 118 may be octagonal-shaped with 40 openings 126 arranged in clusters. The shape of the tray 118 and the arrangement of the openings 126 is customizable depending on the application. The ability to change the size, shape and number of openings enables the apparatus 100 to be reduced in overall size to accommodate space constraints in the salon. Moreover, the overall size of the apparatus 100 can be reduced if the particular application requires a small number of canisters 120. For example, the salon may offer a limited amount of color formulations thus only needing 10 canisters 120 instead of up to 50 canisters 120.

In this configuration, a shaft 166 has an extension 168. The shaft 166 may be coupled to the tray 118 such at the center of the tray 118. A plate 150 with an instrument 152 is coupled to the shaft 166. The instrument 152 may be a strain gauge. A receptacle 154 is coupled to a plate 150 in a dispensing area 108. The aligning of the selected canister 120 with the dispensing area 108 is by the drive mechanism 124. The drive mechanism 124 is configured to rotate the shaft 166 thus also rotating an extension 168, and plate 150, while the tray 118 is stationary. The drive mechanism 124 may be a motor coupled to gears, and a bearing 170 may be coupled to the shaft 166 or tray 118 to enable the rotation of the shaft 166.

For example, the reader 136 may be coupled to the shaft 166, the extension 168 or the plate 150. In this way, when the shaft 166 is rotated by the drive mechanism 124, the reader 136 can identify the selected canister 120. Once the selected canister 120 is identified, the selected canister 120 is aligned with the dispensing area 108. The controller 116 communicates with the drive mechanism 124 to align the selected canister 120 with the dispensing area 108. The controller 116 also communicates with the actuator 144 which activates and positions the lever arm 146a, 146b with the projection 148a, 148b directly above the selected canister 120. The projections 148a, 148b or additional dispenser component within the device may apply a downward force on the selected canister 120 while the projection 148a, 148b is in direct contact with top surface of the canister 120. This opens the valve 130 of the canister 120 and causes dye to escape through the nozzle assembly 500 attached to the canister 120. This may be collected in the receptacle 154. This may be repeated until all of the contents of the dye formulation have been dispensed. The nozzle assembly 500 on the canister 120 may be cleaned of residue by the wiper 400. As the shaft 166 rotates, the wiper 400 contacts the nozzle assembly 500 removing residue.

It should be realized that other dispensing configurations may also be used. For example, a dispenser plate may be configured to rise from beneath the nozzle assembly 500 and press on the nozzle from below to dispense dye. Any method or system which results in a pressure being applied to the nozzle or canister such that dye is dispensed is within the scope of the present system.

According to one example embodiment, the system 110 may be used to dispense dye in the following manner. The canister 120 is aligned with a dispensing area 108, the projections 148a, 148b apply a force on the canister 120 and dispense the dye. For example, the controller 116 communicates with the reader 136. The reader 136, based on the identifier 128, identifies a selected dye in a selected canister 120 associated with the dye formulation. The selected canister 120 is aligned with the dispensing area 108. The controller 116 communicates with the projections 148a, 148b which apply a downward force on the selected canister 120 while the projection 148 is in direct contact with top surface of the canister 120. This opens the valve of the canister 120 and causes dye to escape through the nozzle 132 of the canister 120. The dye 134 is dispensed in quantities such as 0.01 grams to 140.00 grams and in any programmed ranges.

The controller 116 starts and stops the dispensing of the dye allowing for variable dispensing rates. For example, the dispensing may start slow, increase, level off and then decrease as it approaches dispensing the required amount of dye. The rate of dispensing may be customized depending on the amount of dye to be dispensed and the time the apparatus 100 needs to complete the dye formulation.

A user may enter various commands into the dye dispensing system 110. One such command may require the apparatus 100 to undergo a cleaning process. This process would initialize the apparatus 100 to dispense a small amount of dye from each canister 120 and to subsequently wipe each duckbill nozzle assembly 500 against a wiper assembly 200. Alternatively, the cleaning apparatus may require the apparatus 100 to clean a single canister. The dye dispensing system 110 may further track when and how often each canister 120 is wiped and dispensed. The dye dispensing system 110 may further track how full each canister 120 is.

The dye dispensing system 110 may prompt the user to initiate the cleaning process if one or more canisters 120 has not been dispensed or wiped within a specific time period. This time period could be a set number of hours, days, or weeks. The dye dispensing system 110 may also prompt the user to initiate the cleaning process at the start or end of each day. The dye dispensing system 110 may also prompt the user to initiate the cleaning process when a canister 120 is low on dye. Additionally, the prompt may come before or after a canister 120 is replaced.

In other embodiments, the dye dispensing system 110 may prompt the user to initiate the cleaning process based on the activity of the apparatus 100. For instance, a prompt may be sent after a certain number of dispenses of the apparatus 100. The dye dispensing system 110 may set a threshold number of dispenses before the user is notified of the prompt such as every 50 or 100 dispenses.

The dye dispensing system 110 may also notify a user to remove and clean the wiper assembly 200, in addition to, or instead of, the prompting the user to initiate the cleaning process. Like the cleaning prosses notification, the notification to clean the wiper assembly 200 may be based on either canister use or time since last cleaning.In certain embodiments, the dye dispensing system 110 may be configured to track inventory and generate reports. For example, the identifier 128 of each canister 120 may be read during installation, and thereby the dye dispensing system 110 may monitor, track and reorder inventory. A self-diagnostic scan may be performed by the controller 116 or reader 136, or a combination of the two, to monitor the current operation status, location errors, warnings or failures.

In certain embodiments, the dye dispensing system 110 may automate the reordering process of the canisters 120 and salon payment processes. For example, an inventory management system may initiate replacement orders. The orders may be fulfilled by a vendor that provides automatic shipping thus saving the salon owner inventory carrying costs and management labor. The inventory may be vetted against shipping data to track the information from order to delivery. The canisters 120 with the dyes 134 may be automatically invoiced and purchased electronically and automatically thus minimizing the payment effort and streamlining the processing of accounts payable system implemented in a salon. In some embodiments, the method has a tiered marketing strategy offering direct sales to top tier salons and manufacturer representatives for lower tiers. In other embodiments, factory direct shipping of the canister reduces shipping costs and outer packaging.

In further embodiments, the apparatus 100 and system 110 can dispense other liquids such as, for example, developer, shampoo, conditioner, lightener, additives/treatments, or any combination thereof.

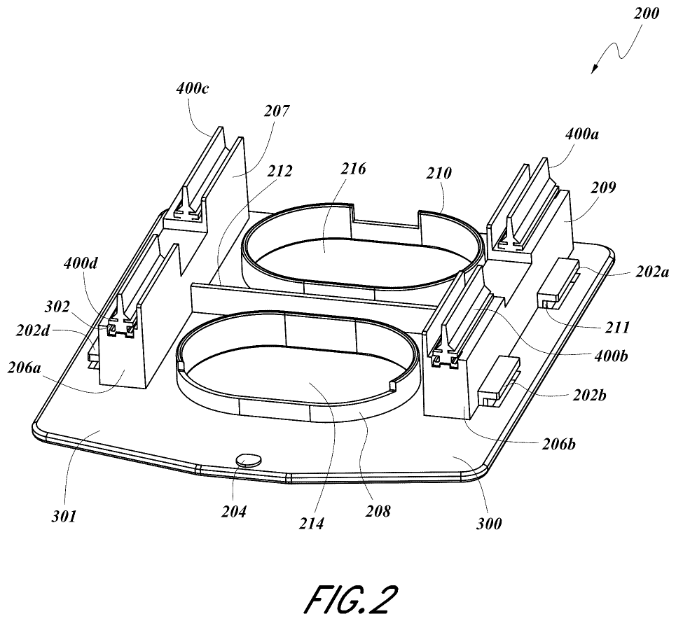

FIG. 2 shows an example embodiment of the wiper assembly 200 not attached to the tray 118. The wiper assembly includes a wiper plate 300 and wipers 400a-d which attach to the plate in four separate positions. In this embodiment, there are four wipers, wipers 400a-d that are attached to the wiper plate 300.

The wiper plate 300 may be made of a single piece of material and has a flat surface 301 with two openings, the first opening 214 and the second opening 216. The openings are bordered by border walls 208 and 210 that extend from the flat surface 301 in a vertical direction. Here the first border wall 208 surrounds the first opening 214 and the second border wall 210 surrounds the second opening 216. The openings may vary in size and shape. In this embodiment, the openings are oval in shape. In other embodiments, the openings may be square, rectangular, circular, or any other orthogonal shape. In use, a canister may wipe a nozzle against one of the wipers 400a-d before or after dispensing dye through one of the openings.

Separating the border walls is a sectional wall 212 that runs between first border wall 208 and second border wall 210. Perpendicular to the sectional wall 212 are protrusions 206a-b as depicted by a first protrusion 206a and a second protrusion 206b. The sectional wall 212 spans the distance between each protrusion 206a,b and contacts an inside surface 207 of each. The inside surface of the protrusions 206a,b is the surface facing the one or more openings. The protrusions 206a,b are spaced apart so that the several openings and the corresponding border walls fit between the protrusions 206a,b. The outside surface 209 of each protrusions 206a,b face away from the openings.

The wipers 400a-d may be coupled to the protrusions 206a,b of the wiper plate 300. As shown, a first wiper 400a and a second wiper 400b are coupled to the second protrusion 206b and a third wiper 400c and a fourth wiper 400d are coupled to a first protrusion 206a. All wipers 400a-d are coupled in parallel to one another and perpendicular to the sectional wall 212. Further, each of the wipers 400a-d is positioned such that they are substantially in line with the one or more openings. For example, the second wiper 400b and the fourth wiper 400d are in line with the opening defined by first border wall 208 while the third wiper 400c and the first wiper 400a are in line with the opening defined by second border wall 210.

Thus, as a canister is moved in and out of alignment with an opening to dispense dye, it is wiped by a wiper 400a-d. For example, as a canister is moved to dispense dye through the second opening 216 surrounded by second border wall 210, the canister may first be wiped by the third wiper 400c or the first wiper 400a. After the canister has dispensed the dye and is moved out of alignment with the second opening 216 and may be wiped a second time by either the third wiper 400c or the first wiper 400a. Note that it is possible to wipe the nozzles in both directions. Doing so has additional benefits since it provides a different angle to perform the wiping job and allows the residual product to be spread across more surfaces, thus allowing longer times between having to clean the wipers.

In certain embodiments, the wipers 400a-d are each coupled to the protrusions 206a,b by a channel that secure the wipers 400a-d in place. In other embodiments the wipers 400a-d are coupled to the protrusions 206a,b magnetically, with or without the use of a channel. In still other embodiments, the wipers 400a-d are coupled to the protrusions 206a,b using adhesion, friction, or weld.

A set of mounting clips 202a-d are located on the flat surface 301 of the wiper plate 300 and positioned near the outside surface 209 of each protrusion 206a, b. The clips 202a-d consist of a portion of the flat surface 301 that has been elevated to expose a cutout that extends through the flat surface 301. The elevated portion of the flat surface 301 and the associated cutout are rectangular in shape. The elevated portion of each clip is connected to the flat surface 301 by a vertical member 211. In this embodiment, there are four clips 202a-d near each of the protrusions 206a,b. A first clip 202a and a second clip 202b are positioned near the outside surface 209 of the second protrusion 206b, while a third clip 202c (not shown) and a fourth clip 202d are positioned near the outside surface 209 of the first protrusion 206a. The clips 202a-d may be used to couple the wiper plate 300 to the rest of the hair dye dispensing apparatus 100.

A protruding bump 204 is located on the flat surface 301 of the wiper plate 300. As shown, the bump 204 is located midway between the protrusions 206 and near an edge of the flat surface 301. In various embodiments, the position of the bump 204 may be located anywhere on the flat surface 301. The bump 204 may engage with a sensor to notify the dye dispensing system 110 when the wiper plate 300 has been attached to the dispensing system or apparatus 100. The bump 204 may have a ramp or wedge shape on one side to allow a smooth engagement into the sensor, but lock in place once installed so it will not back out easily. In some embodiments, this bump 204 may engage with a switch sensor, a micro switch sensor, or an optical sensor, or may contain a magnet to engage with a magnetic sensor. In other embodiments, the bump 204 may be an identifier implementing RFID (radio-frequency identification) technology, NFC (near-field communication) technology or the like which notifies the dye dispensing system 110 that the wiper plate 300 has been installed.

The wiper plate 300 may be removed from the apparatus 100, and the wipers 400 may be removed from the wiper assembly 200 for cleaning or replacement. In certain embodiments, installation and removal of the wiper plate assembly 200 may be done horizontally as the wiper plate 300 may slide into the apparatus 100. In some embodiments, the wiper plate assembly 200 is installed and removed vertically from the apparatus 100.

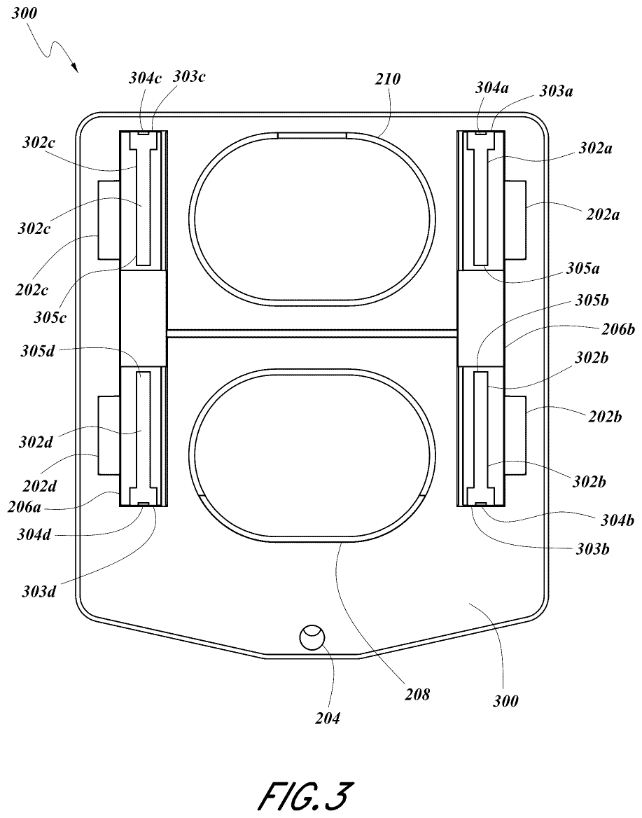

FIG. 3 is a top view of an embodiment of the wiper plate 300 without the wipers 400a-d attached. Here, the wipers (e.g. 400a-d, not shown) are inserted into channels 302a-d. Each channel 302a-d consists of a channel entry 303a-d and a channel body 305a-d. While the channels 302a-d are uniform in shape, the channel entries 303a-d and the channel bodies 305a-d indicate differences in the size and shape of the vertical opening that runs along the length of the channels 302a-d and allows for the wipers 400a-d to protrude from the channels 302a-d. The channel entry 303a-d has a wide vertical opening which allows for easy insertion of the wiper 400a-d into the channel 302a-d. The channel body 305a-d has a narrow vertical opening which holds the wiper 400a-d in place. Further, each channel entry 303a-d features a ridge 304a-d. This ridge 304a-d helps to secure the wiper 400a-d in place and prevents the wiper 400a-d from sliding out after insertion into the channel 302a-d.

In some embodiments, each channel 302a-d may have a wiper sensor. This sensor would notify the hair dye dispensing system 110 of the presence of absence of the wiper 400. In certain embodiments, this sensor is a switch sensor, a micro switch sensor, an optical sensor, or magnetic sensor.

The wiper plate 300 may be made from a single material or a combination of materials. Further, the wiper plate 300 may be a single unitary piece or it may be assembled from separate pieces. In some embodiments, the protrusions 206a, b, the flat surface 301, and/or the border walls are all separate pieces. In some embodiments, the material of the wiper plate 300 is plastic, rubber, or polymer based. In other embodiments, the wiper plate 300 is made from a metal such as aluminum, steel, or alloy. The wiper plate 300 may also be made of a fiber-based material such as carbon fiber or fiberglass.

In some embodiments, the wiper plate 300 may be injection molded, milled, or 3D printed.

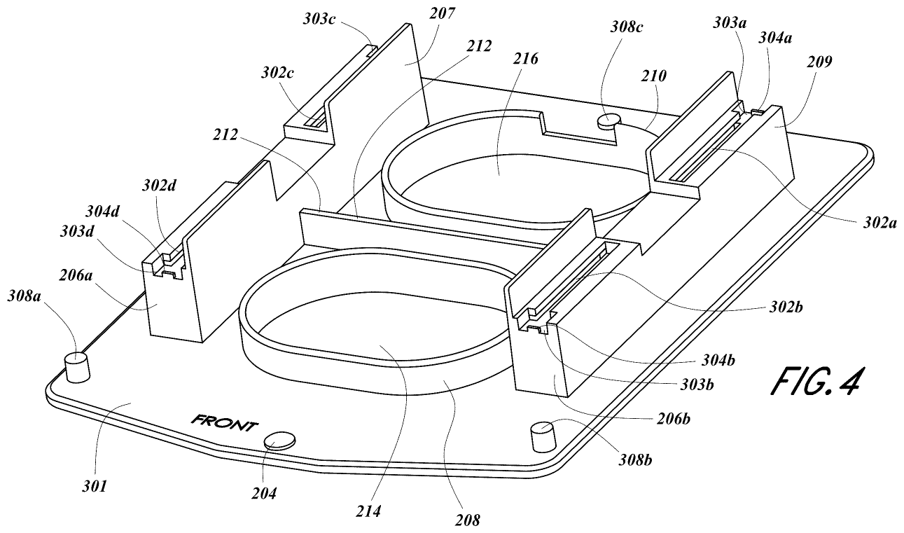

FIG. 4 is an isometric view of the wiper plate 300 according to an embodiment that utilizes a magnetic attachment. This wiper plate 300 is similar to the wiper plates described in FIGS. 2-3 and has many of the same features (i.e. the inside surface 207, first border wall 208, outside surface 209, second border wall 210, sectional wall 212, first opening 214, second opening 216, first protrusion 206a, second protrusion 206b, channel 302a-d, channel entry 303, and ridge 304a-d). One notable difference is that the wiper plate 300 does not include any clips or corresponding cutouts. Further, the bump 204 is not tapered but may be symmetrical on all sides. Locating posts 308a-c protrude away from a flat surface 301 and are located near a left and right corner of the wiper plate 300 on the side closest the bump 204, and also centrally on the side opposite the bump 204. These posts 308a-c may be cylindrical in shape and help to ensure proper orientation when installing the wiper plate into the apparatus 100. In an embodiment, the wiper plate 300 may be vertically installed and magnetically attached to the apparatus 100. In some embodiments, the wiper plate 300 may be made of a magnetic material. In some embodiments, magnets may be attached to the wiper plate 300. In certain embodiments, upon installation, the wiper plate 300 will magnetically attach to the apparatus 100 and the locating posts 308a-c may ensure the wiper plate 300 is properly oriented and prevent misalignment if the wiper plate 300 is bumped or moved.

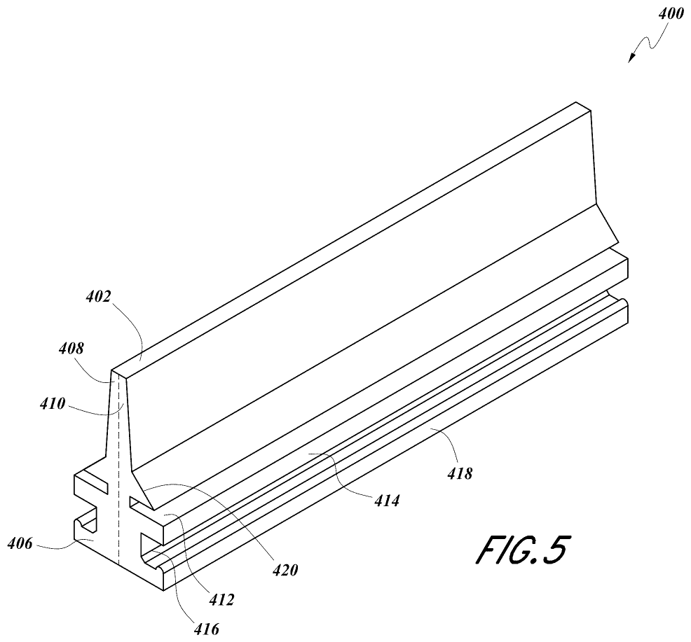

FIG. 5 is an isometric view of a wiper 400 according to an embodiment. The wiper 400 has a two-dimensional front surface 406 that has been extruded to form the three dimensional wiper 400. An axis 408 is shown that bisects a front surface 406. The front surface 406 is symmetrical about this axis 408 and the following description is relative to the front surface 406. The wiper 400 has an upper portion and a lower portion. The upper portion of the wiper 400 has a tapered wiping blade 410, a trapezoidal flange 420, a bending groove 412 and a stabilization bar 414. The lower portion of the wiper 400 has a mounting channel 416, and a bottom flange 418. The lower portion ensures that the wiper 400 is secure within the channel 302 while the upper portion is used for securing the wiper 400 and also cleaning the duckbill nozzle assembly 500.

The tapered wiping blade 410 is narrowest at the top where it meets an upper surface 402 and widest at the bottom where it meets the trapezoidal flange 420. The trapezoidal flange 420 resembles an upright trapezoid where the legs of the trapezoid angle away from the axis 408 as the distance from the upper surface 402 increases until the legs meet the bending groove 412. The bending groove 412 resembles a horizontal rectangular cutout of the front surface 406 where the base of the trapezoidal flange 420 and the upper surface of the stabilization bar 414 form the parallel sides of the rectangle and are separated by a distance. The stabilization bar 414 resembles a horizontal rectangle and extends away from the axis 408. Beneath the stabilization bar 414 is the mounting channel 416 which is bounded by the bottom flange 418. The bottom flange 418 extends horizontally away from the axis 408 and is raised vertically at its edges.

The tapered wiping blade 410 and the bending groove 412 allow for the wiper 400 to bend and flex as it wipes. As the tapered wiping blade 410 bends, the bending groove 412 accommodates any displacement of the trapezoidal flange 420.

Further, the tapered wiping blade 410 and trapezoidal flange 420 are angled so that substances such as the dispensed dye can roll off the wiper 400 without getting stuck in the bending groove 412.

The bottom portion of the wiper 400 fits within the channel 302 while the upper portion of the wiper 400 extends from the channels 302 vertical opening. When coupled to the wiper plate 300 of FIGS. 1-2, the bottom flange 418 fits within the channel 302. The mounting channel 416 of the wiper 400 accommodates a portion of the protrusions 206a,b which make up the narrow vertical opening of the channel body 305. The bending groove 412 of the wiper 400 extends vertically out of the channel 302 and rests on the top surface of the channel body 305. Thus, the wiper 400 maintains several points of contact with the protrusions 206a,b both within and above the channel to ensure that the wiper 400 is securely positioned.

In some embodiments, the wiper 400 is made from a single material or combination of separate materials. In an example embodiment, the material of the wiper 400 is silicone. In another embodiment, the material is a rubber, polymer, plastic or elastomer. In other embodiments the material is made of a fiber-based compound. In other embodiments, the upper portion of the wiper 400 is made from a different material than the lower portion of the wiper 400. In one such embodiment, the lower portion of the wiper 400 is made of a rigid material while the upper portion of the wiper 400 is made of an elastomer material.

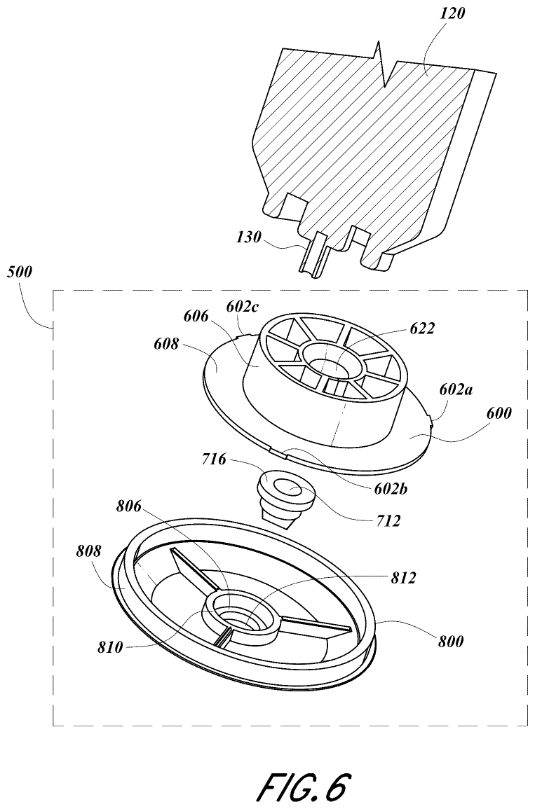

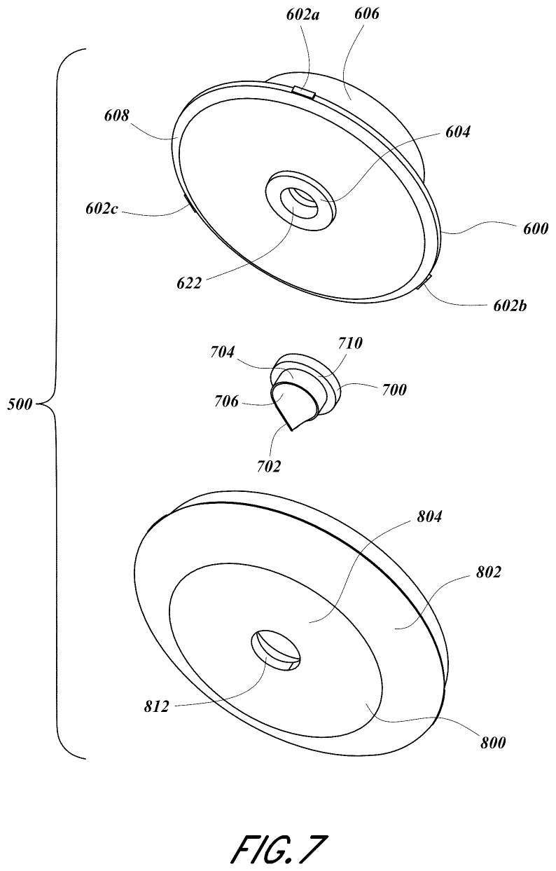

FIG. 6 is an isometric top view according to an example embodiment of a duckbill nozzle assembly 500 with a canister 120 and FIG. 7 is an isometric bottom view of the duckbill nozzle assembly 500. The canister 120 has a valve 130 which is inserted into the duckbill nozzle assembly 500. In use, a substance of the canister 120 flows through this valve 130 into the duckbill nozzle assembly 500. The duckbill nozzle assembly 500 is made up of three distinct parts. There is an upper nozzle 600, a lower nozzle 800, and a duckbill nozzle 700.

The upper nozzle 600 features a valve housing 606, a locking plate 608 with an upper and lower surface, hooks 602a-c, and a raised rim 604. The valve housing 606 and the locking plate 608 are both cylindrical in shape and concentric with each other. The valve housing 606 protrudes from the flat upper surface of the locking plate 608 and extends in the direction of the canister 120. The upper nozzle 600 features an upper aperture 622 that extends through the center of the valve housing 606 and the locking plate 608.The locking plate 608 features hooks 602a-c that extend radially from the outer circumference of the locking plate 608. The lower surface of the locking plate 608 features a raised rim 604 which extends in a direction normal to the flat lower surface and away from the canister 120. This raised rim 604 surrounds the upper aperture 622 that passes through the upper nozzle 600.

The valve housing 606 is configured to attach to the canister 120 such that the valve 130 is inserted into the valve housing 606 and the valve housing 606 grips the canister 120.

The lower nozzle 800 is conical in shape and features a smooth plate 804 which forms the base of the cone and an inverted edge 802 which extends away from the smooth plate 804. A lower aperture 812 extends through the center of the smooth plate 804. A ring wall 808 extends from the upper portion of the inverted edge 802 in the direction of the canister 120 and forms a ring around the lower nozzle 800. This ring wall 808 is concentric with the inverted edge 802 and smaller in diameter such that the end of the inverted edge 802 is offset from the ring wall 808. A rib wall 810 extends from the inside surface of the smooth plate 804 in the direction of the canister 120. This rib wall 810 in concentric with the lower aperture 812 such that it forms a ring around the lower aperture 812. Further, the rib wall 810 may extend radially away from the ring in a manner where it contacts the inside of the inverted edge 802. As shown in FIG. 6, the rib wall 810 extends radially at three points that are equally spaced around concentric ring portion of the rib wall 810. The concentric ring portion of the rib wall 810 is greater in diameter than the lower aperture 812 such that a resting rim 806 exists between the lower aperture 812 and the rib wall 810. This resting portion is cylindrical in shape.

The duckbill nozzle 700 features a base portion 710, a center piece 704, a tip 706, and a flat slit 702. The base portion 710 is cylindrical in shape and abuts the center piece 704. The center piece 704 is also cylindrical in shape but has a smaller diameter than the base portion 710 it contacts. The tip 706 abuts the opposite end of the center piece 704. The shape of the tip 706 is best described as resembling that of a duckbill. The tip 706 is cylindrical where it contacts the center piece 704 but tapers into the flat slit 702. A duckbill aperture 712 is shown extending through the duckbill nozzle 700.

During assembly of the duckbill nozzle assembly 500, the duckbill nozzle 700 may be inserted into the lower aperture 812 of the lower nozzle 800. The base portion 710 of the duckbill nozzle 700 contacts the resting rim 806 of the lower nozzle 800 while the center piece 704 extends through the lower aperture 812 and the tip 706 protrudes from the lower surface of the lower nozzle 800. The resting rim 806 keeps the duckbill nozzle 700 from falling through the lower aperture 812 of the lower nozzle 800 while the rib wall 810 secures the duckbill nozzle 700 so that it remains concentric with the lower aperture 812. The upper nozzle 600 is then placed on top of the duckbill nozzle 700 such that the raised rim 604 of the upper nozzle 600 contacts the base portion 710 of the duckbill nozzle 700. This secures the duckbill nozzle 700 in place and prevents any vertical displacement or product leaking out the sides when it is dispensing. The lower surface of the locking plate 608 further contacts the rib wall 810. Thus, the upper nozzle 600 fits inside the ring wall 808 of the lower nozzle 800. The circumferential edge of the locking plate 608, including the hooks 602a-c may contact the inside of the ring wall 808 in the assembled state.

The upper nozzle 600 and lower nozzle 800 may be coupled in a variety of manners. In one embodiment, the coupling may be achieved by ultrasonic welding or heat staking. In another embodiment, the coupling may be achieved by a press fit or friction fit. In other embodiments, the coupling may be achieved through use of an adhesive. In some embodiments, the coupling may be achieved using the hooks 602a-c to clip or hook onto the ring wall 808. In some embodiments, the number of hooks may exceed the three that are depicted. In some embodiments, the upper nozzle 600 does not have any hooks.

The upper nozzle 600 and the lower nozzle 800 may be made of a plastic, rubber, or polymer-based material. In other embodiments, this material may be made of a metal such as aluminum, steel, or an alloy. In other embodiments, this material could be a fiber-based material such as carbon fiber or fiberglass.

The duckbill nozzle 700 may be made of a silicone, rubber, polymer, plastic, or elastomer material. In some embodiments, the duckbill nozzle 700 may be made of Teflon or coated in a non-stick material. The size of the duckbill nozzle 700 may vary, for example, the inner diameter, or duckbill aperture 712, and/or the flat slit 702 opening may be 2.8 mm for some products, but could vary from 1.4 mm to 9.6 mm, depending on product viscosity and dispensing accuracy needs. Smaller-sized nozzles will dispense more slowly but be more accurate, whereas larger-sized nozzles will dispense more quickly but be less accurate. The upper and lower nozzle may be injection molded, milled, or 3D printed.

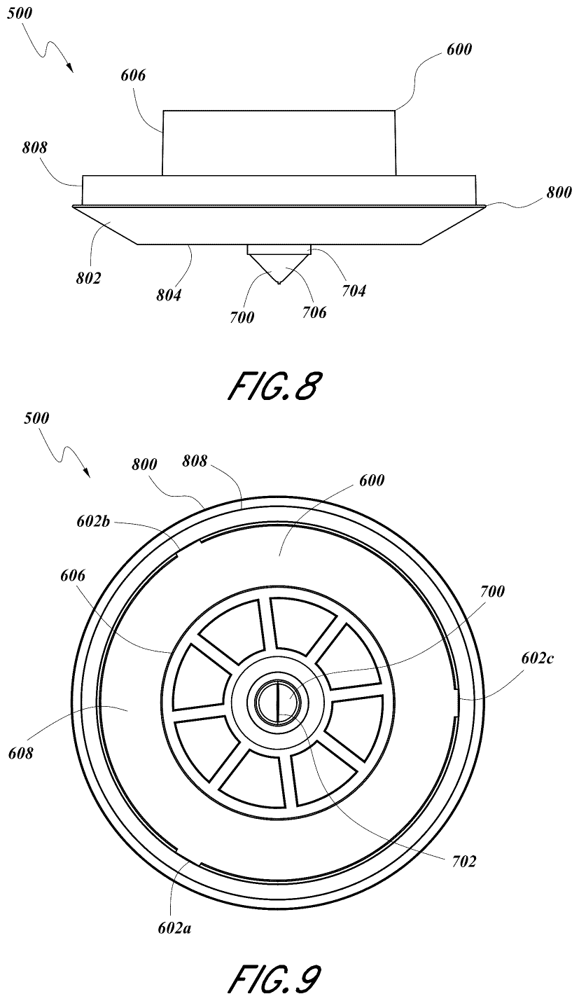

FIG. 8 is a side view of an example embodiment of the duckbill nozzle assembly 500 in an assembled state.

As shown, the tip 706 and a portion of the centerpiece 704 of the duckbill nozzle 700 extend past the smooth plate 804 of the lower nozzle 800. Further, the valve housing 606 of the upper nozzle 600 extends from behind the ring wall 808 of the lower nozzle 800. The locking plate 608 is not visible as it is behind the ring wall 808.

FIG. 9 is a top view of an example embodiment of the duckbill nozzle assembly 500 in an assembled state. As shown, the hooks 602 and locking plate 608 of the upper nozzle 600 are in contact with the ring wall 808 of the lower nozzle 800. The valve housing 606 extends from the locking plate 608 and surrounds the upper aperture (e.g. 622) of the upper nozzle 600. Further, the duckbill nozzle 700 is visible within the upper aperture 622 and the flat slit 702 is visible.

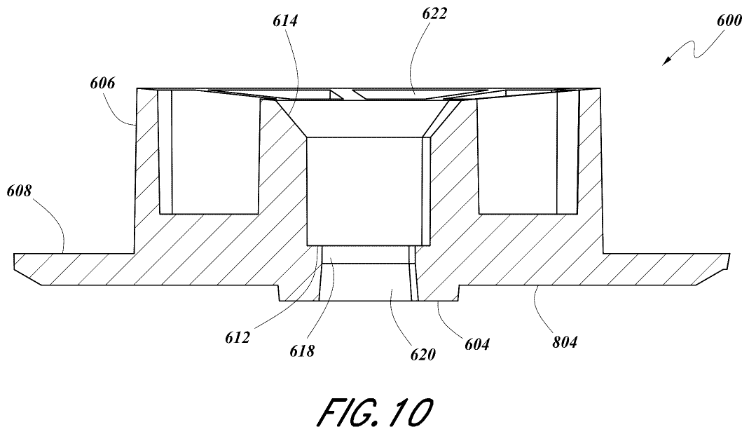

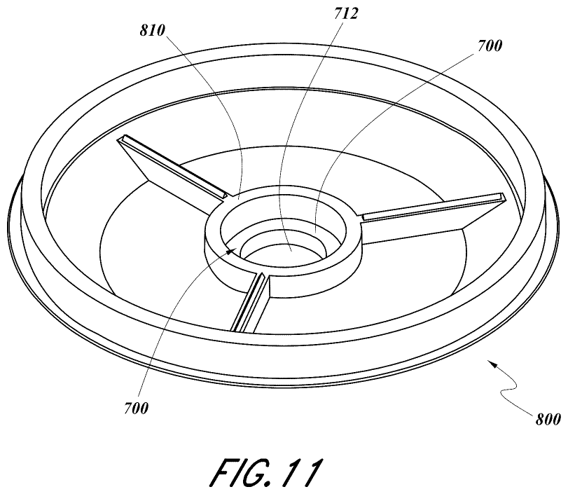

FIG. 10 is an example embodiment of a sectional view of the upper nozzle 600. As shown, the valve housing 606 extends from the top surface of the locking plate 608. The upper aperture 622 varies in diameter as it passes through the valve housing 606 and locking plate 608 portions of the upper nozzle 600. The upper aperture 622 is defined by various features of the valve housing 606 and the locking plate 608. These features include a valve funnel 614, a valve rest 612, a fluid channel 618, and a diffuser 620. The valve funnel 614 is located near the upper surface of the valve housing 606 and is shaped as a funnel which surrounds the upper aperture 622. The valve rest 612 abuts the valve funnel 614. The valve rest 612 is cylindrical in shape and vertically defines a portion of the upper aperture 622. The fluid channel 618 abuts the valve rest 612 and is also cylindrical in shape but substantially smaller in diameter than the valve rest 612. Thus, the fluid channel 618 substantially narrows the diameter of the upper aperture 622 in comparison to the valve rest 612. The diffuser 620 abuts the fluid channel 618 and expands the size of the upper aperture 622 which ends at the raised rim 604.

The valve funnel 614 serves to guide the valve (e.g. 130) into the valve rest 612. The valve rest 612 serves to accommodate the valve 130 as it is inserted into the valve housing 606. The valve rest 612 also prevents the valve 130 from going further into the aperture. The fluid channel 618 allows for fluid to pass from the valve 130 of the canister 120 and into the diffuser 620. The diffuser 620 slows the velocity of the fluid before it enters the duckbill nozzle 700. Different sized fluid channels 618 or diffusers 620 can be used to control the flow rate of the product and accommodate a wide variety of different viscosities and types of products.

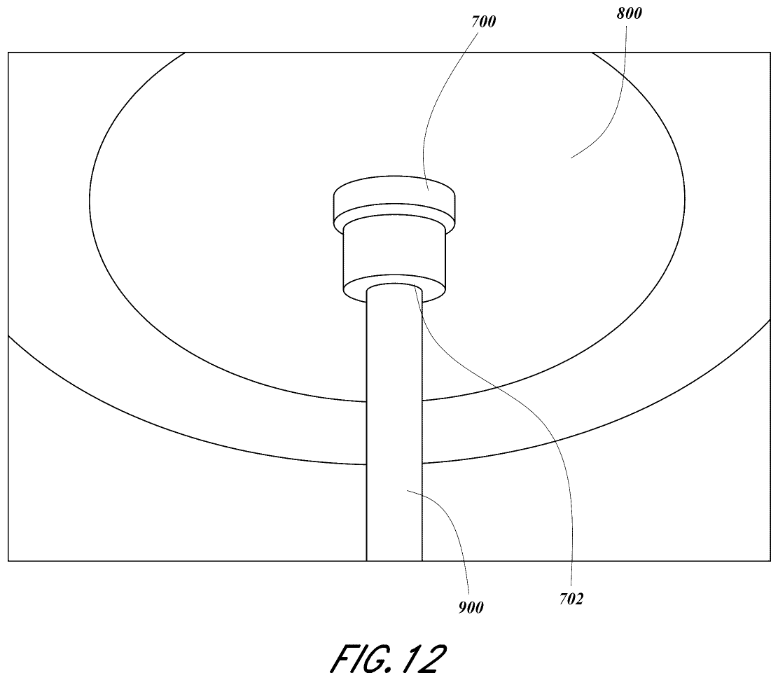

FIG. 11 is an isometric view of an example embodiment of the duckbill nozzle 700 assembled with the lower nozzle 800. As shown, the duckbill nozzle 700 fits within the rib wall 810 of the lower nozzle 800. When assembled with the upper nozzle 600, the raised rim 604 contacts the duckbill nozzle 700 thus allowing for the diffuser (e.g. 620) of the upper aperture (e.g. 622) to be in fluid communication with the duckbill aperture 712.

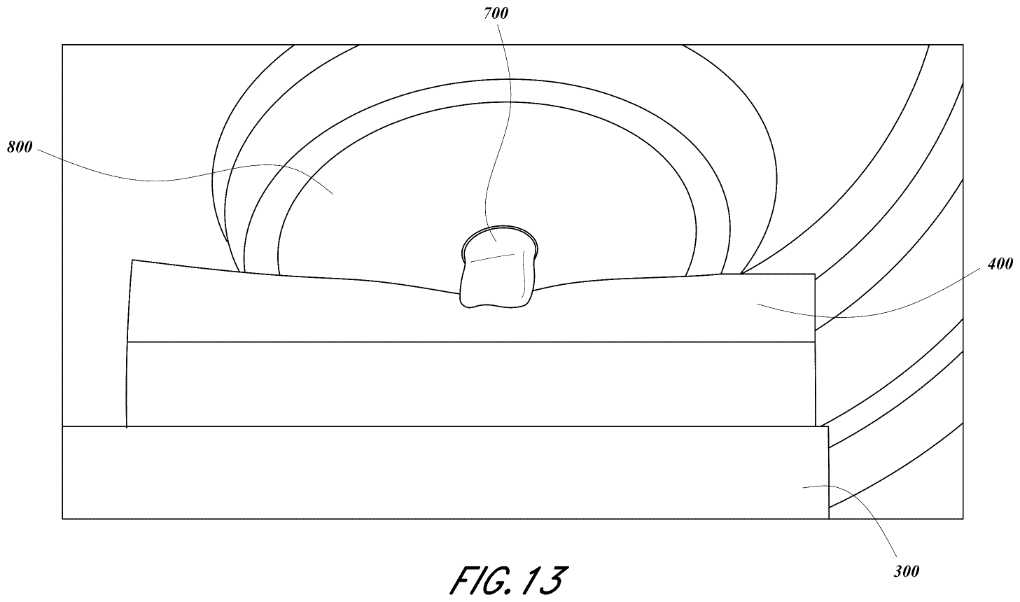

FIG. 12 shows the duckbill nozzle assembly 500 in use according to an example embodiment. Here a fluid 900 is shown dispensing from the duckbill nozzle 700. The flat slit 702 of the duckbill nozzle 700 is shown in an open state which allows for the fluid 900 to dispense. When the dispensing stops, the flat slit 702 will revert to a closed state which seals off the inside of the duckbill nozzle assembly 500 to prevent the inside product from drying and clogging. The flat slit 702 can open and close due to the material properties of the duckbill nozzle 700 and the shape of the duckbill nozzle 700.

FIG. 13 shows the wiper assembly 200 and duckbill nozzle assembly 500 engaged in cleaning. Here, the duckbill nozzle 700 is shown contacting the wiper 400 which is held by the wiper plate 300. This effectively serves to cleanse the duckbill nozzle 700 before and after fluid is dispensed from the nozzle.

Here, the wiper 400 contacts the duckbill nozzle 700 in order to remove any excess fluid from the tip of the duckbill nozzle 700. The wiper 400 may also contact the smooth plate 804 of the lower nozzle 800 to remove any extra fluid. Alternatively, the wiper 400 and the duckbill nozzle assembly 500 may be arranged such that there is a tolerance of 0.001 meters between the wiper 400 and the smooth plate 804. In some embodiments, this tolerance may range from 0.0005 meters to 0.0015 meters. In some embodiments, the wiper 400 may overlap with the duckbill nozzle 700 by about 1 mm. In some embodiments, this overlap may range from 0.5 mm to about 1.5 mm. In some embodiments, the position of the wiper plate 300 with respect to the tray 118, or canister 120 is adjustable such that the distance between the wiper 400 and the duckbill nozzle 700 may be adjusted. In some embodiments, the user may manually make this adjustment or enter a command into the dye dispensing system 110 which may automate this adjustment. In some embodiments, the system may choose to make these adjustments based on firmware. The amount of overlap may be adjusted to ensure that the duckbill nozzle 700 is not over wiped which may result in product smeared across the duckbill nozzle assembly 500 or other components of the apparatus 100, and to ensure that the duckbill nozzle 700 is not under wiped.

After fluid 900 is dispensed from the duckbill nozzle 700 there may be left over fluid that hangs from the duckbill nozzle 700 or that remains inside of the duckbill nozzle 700. This is problematic as the leftover fluid 900 may spread throughout the hair dye dispensing apparatus 100 if it is not cleaned properly. This not only causes a mess but also may inhibit the mechanical functionality of the system. Further, leftover fluid 900 in the duckbill nozzle 700 may harden and effect the distribution of fluid 900 from the duckbill nozzle 700 during future use. Utilizing the features of the duckbill nozzle 700 and the wiper 400 together allow for a high amount of fluid to be removed from the duckbill nozzle 700. Further any fluid that which remains is sealed within the duckbill from the outside air, which helps prevent it from drying and clogging.

The wiper assembly 200 and duckbill nozzle assembly 500 work together to remove excess dispensed fluid from the apparatus 100. The duckbill nozzle assembly 500 reduces the amount of dispensed fluid that clings to the duckbill nozzle assembly 500 because of the self-sealing capabilities of the duckbill nozzle 700. Further, the design of the duckbill nozzle 700 keeps the fluid flow from the duckbill nozzle 700 consistent and laminar such that it dispenses in a uniform direction. The wiper 400 may wipe the duckbill nozzle assembly 500 to remove any excess fluid that may have clung to the duckbill nozzle 700 or the lower nozzle 800. Further, due to the material properties of the duckbill nozzle 700, the duckbill nozzle 700 may temporarily deform upon contact with the wiper 400 such that any excess fluid that was within the he duckbill nozzle 700 would be pressed out of the flat slit 702 by the wiper 400.

In some embodiments, the wiper assembly 200 may be raised or lowered with respect to duckbill nozzle assembly 500. The user may do this manually or may command the dye dispensing system 110 to perform this task.

Using the wiper assembly 200 and duckbill nozzle assembly 500 together prevent clogs in the nozzle, ensure that the fluid or dye is dispensed straight down into a receptacle, and keep the dye dispensing system clean from residual dispensed fluids.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the scope of the present invention. Furthermore, those of ordinary skill in the art will appreciate that the foregoing description is by way of example only, and is not intended to limit the invention. Thus, it is intended that the present subject matter covers such modifications and variations.

1. A product dispensing nozzle assembly comprising:
an upper nozzle plate adapted to mate with a canister and a duckbill valve; and
a lower nozzle plate coupled to the upper nozzle plate and comprising a central through hole traversed by the duckbill valve,
wherein the duckbill valve comprises an elastomeric tip which is self-closing.

2. The nozzle assembly of claim 1, wherein the upper nozzle plate comprises an aperture configured to receive a valve of the canister.

3. The nozzle assembly of any of claim 2, wherein the aperture is located within an extruded housing portion of the upper nozzle plate.

4. The nozzle assembly of claim 2, wherein the upper nozzle plate comprises a diverter which forms a part of the aperture.

5. The nozzle assembly of claim 1, wherein the duckbill valve further comprises a base portion which is secured between the lower nozzle plate and the upper nozzle plate.

6. The nozzle assembly of claim 5, wherein the base portion features an inlet, wherein the inlet is in fluid communication with a diverter of the upper nozzle plate.

7. The nozzle assembly of claim 1, further comprising one or more hooks coupling the upper nozzle plate to the lower nozzle plate.

8. The nozzle assembly of claim 1, wherein the upper nozzle plate is coupled to the lower nozzle plate by means of one or more of an ultrasonic weld, heat stake, glue, or mechanical fastener.

9. The nozzle assembly of claim 1, wherein the lower nozzle plate is conical in shape.

10. The nozzle assembly of claim 9, wherein the lower plate further comprises a ring wall that extends vertically from an inverted portion of the conical shape, and wherein the ring wall accommodates the upper nozzle plate.

11. The nozzle assembly of claim 1, wherein the lower nozzle plate comprises a rib wall.

12. The nozzle assembly of claim 11, wherein the rib wall is concentric with, and offset from, the central through hole.

13. The nozzle assembly of claim 1, wherein the elastomeric tip comprises silicone.

14. A hair dye dispensing system, comprising:
a dispenser configured to dispense hair dye into a receptacle, the dispenser comprising:
an upper nozzle plate adapted to mate with a duckbill valve; and
a lower nozzle plate coupled to the upper nozzle plate and comprising a central through hole traversed by the duckbill valve,
wherein the duckbill valve comprises an elastomeric tip which is self-closing; and
a controller configured to control the dispenser to dispense hair dye through the duckbill valve and into the receptacle.

15. The hair dye dispensing system of claim 14, wherein the upper nozzle plate comprises an aperture configured to receive a valve of a canister.

16. The hair dye dispensing system of claim 15, wherein the aperture is located within an extruded housing portion of the upper nozzle plate.

17. The hair dye dispensing system of claim 15, wherein the upper nozzle plate comprises a diverter which forms a part of the aperture.

18. The hair dye dispensing system of claim 14, wherein the duckbill valve further comprises a base portion which is secured between the lower nozzle plate and the upper nozzle plate.

19. The hair dye dispensing system of claim 18, wherein the base portion features an inlet, wherein the inlet is in fluid communication with a diverter of the upper nozzle plate.

20. The hair dye dispensing system of claim 14, further comprising one or more hooks coupling the upper nozzle plate to the lower nozzle plate.
